(19) United States
(12) Patent Application Publication
(10) Pub. No.: US 2007/0281213 A1
(43) Pub. Date: Dec. 6, 2007

(54) Carbon Monofluoride Cathode Materials Providing Simplified Elective Replacement Indication

(75) Inventor: Michael Pyszczek, Leroy, NY (US)

Correspondence Address: WALTER W. DUFT;LAW OFFICES OF WALTER W. DUFT, 8616 MAIN ST, SUITE 2, WILLIAMSVILLE, NY, 14221, US

(73) Assignee: GENTCORP LTD., Lancaster, NY (US)

(21) Appl. No.: 11/421,973

(22) Filed: Jun. 2, 2006

(51) Int. Cl. H01M 4/58; H01M 4/62

(52) U.S. Cl. 429/231.7; 429/232; 429/217

(57) ABSTRACT

An electrochemical cell includes an anode, a cathode and an electrolyte operatively associated with the anode and the cathode. The cathode comprises a blend of a first electrochemically active fluorinated carbon material and one or more additional electrochemically active fluorinated carbon materials. The fluorinated carbon materials provide an electrochemical cell voltage characteristic that may be used to predict remaining energy capacity as the electrochemical cell discharges during service. Advantageously, the cathode does not require other electrochemically active materials to achieve the desired voltage characteristic, thereby preserving the favorable energy density properties of fluorinated carbon.

### BACKGROUND OF THE INVENTION

1. Field of the Invention

The present invention relates to electrochemical cells and, more particularly, to primary cells that utilize an anode composed of lithium (or other light metal) and a cathode composed of fluorinated carbon. Still more particularly, the invention is directed to providing an elective replacement indication (ERI) that facilitates the prediction of end-of-life cell depletion in a primary fluorinated carbon battery.

2. Description of Prior Art

Primary electrochemical cells that utilize a light metal anode (most commonly lithium (Li)) and a fluorinated carbon (CFₓ) cathode (hereinafter referred to as “Li/CFx” cells or batteries) have been used to power commercial and medical devices for many years. Advantages of Li/CFx cells include their ability to be easily sealed, their low rate of self-discharge and their high energy density relative to other battery chemistry systems. Another favorable characteristic of Li/CFₓ cells is their ability to provide a consistent, stable output voltage over a large percentage of their discharge cycle. This characteristic allows Li/CFx cells to be used for many applications where a stable voltage source is required throughout battery service life. On the other hand, an Li/CFx cell's normally stable voltage tends to fall off rather precipitously as the cell approaches depletion. The voltage discharge curve of an Li/CFx cell is thus relatively flat over a major portion of the cell's service life, then rapidly transitions to a steep negative slope at the end of service as the output voltage drops rapidly. FIG. 1, which is excerpted from J. Gabano, “Lithium Batteries,” Academic Press, 1983, page 228, illustrates a set of voltage discharge curves that are representative of the voltage drop-off phenomenon. This characteristic becomes a significant liability when Li/CFx cells are considered for use in pacemakers and other implantable medical device applications. In such applications, there is a critical need to accurately predict the time of cell depletion in order that the cell or device may be replaced (via surgical explantation) before the device fails to operate. As a result, Li/CFₓ cells have found limited acceptance for implantable medical use in comparison to other battery chemistries that provide a reliable end-of-life indication, such as Li/SVO (silver vanadium oxide) cells.

Various proposals for predicting the onset of depletion of Li/CFₓ cells are addressed in the prior art. One approach is to provide a blended cathode whose electrochemically active components include a mixture of CFₓ and a non-carbonaceous additive that modifies the voltage characteristics of the cell during discharge. The above-cited Ebel et al. patent is illustrative. This reference discloses cathode mixtures of CFx and an additive selected from the group of metal-containing materials that includes bismuth dioxide (Bi₂O₃), bismuth lead oxide (Bi₂Pb₂O₅), copper sulfide (CuS), copper chloride (CuCl₂), copper oxide (CuO), iron sulfide (FeS), iron disulfide (FeS₂), molybdenum oxide (MoO₃), nickel sulfide (Ni₃S₂), silver oxide (Ag₂O), silver chloride (AgCl), copper vanadium oxide (CuV₂O₅), silver vanadium oxide (AgV₂O_{5.5}), mercury oxide (HgO), lead dioxide (PbO₂), and copper silver vanadium oxide (CuₓAg_{y} V₂ O_{z}). These materials are said to provide a characteristic stepped voltage discharge curve that can be used as an end-of-service indicator.

U.S. Pat. No. 5,180,642 of Weiss et al. similarly discloses cathode mixtures of CFx and an additive selected from the group consisting of vanadium oxide (V₆O_{13+y}), silver vanadates (βAgₓV₂O₅), (δAgₓV₂O₅) and (Ag₂V₄O₁₁), bismuth fluoride (BiF₂) and/or titanium sulfide (TiS₂). These materials are said to provide a characteristic voltage discharge curve wherein the end-of-service voltage drop normally associated with CFx is more gradual such that an end-of-service indication may be obtained.

Another approach that has been used for predicting the onset of depletion of Li/CFₓ cells is to construct a two-part cathode composed of two cathode formulations in distinct layers, one of which is CFx and the other being a different electrochemically active cathode material. In U.S. Pat. No. 4,259,415 of Tamura et al., a main cathode material selected from a group that includes CFx forms a first cathode layer that participates in a primary discharge reaction. A precursor cathode material that provides a second cathode layer takes part in the primary discharge reaction and also produces a sub-positive active material that takes part in a secondary discharge reaction. The precursor material is selected from the group consisting of vanadium pentoxide (V₂O₅), lead dioxide (PbO₂), silver chromate (Ag₂CrO₄), lead chromate (PbCrO₄), silver tungstate (Ag₂WO₄), silver molybate (Ag₂MoO₄) and silver sulfate (Ag₂SO₄). The sub-positive active material has a lower reaction potential than the main cathode material and this is said to result in a secondary discharge voltage characteristic that can be used to determine end-of-service.

In U.S. Pat. No. 6,936,379 of Gan et al., a sandwich cathode is formed with a first cathode material having relatively high rate capability but a relatively low energy density, and a second cathode material having a relatively high energy density and a relatively low rate capability. The primary cathode material can be formed using silver vanadium oxide (AgₓV₂O_{y}), copper silver vanadium oxide (CuₓAg_{y}V₂O_{z}), vanadium oxide (V₂O₅), manganese dioxide (MnO₂), lithium cobalt dioxide (LiCoO₂), lithium nickel dioxide (LiNiO₂), lithium manganese oxide (LiMn₂O₄), titanium disulfide (TiS₂), copper sulfide (Cu₂S), iron sulfide (FeS), copper oxide (CuO), copper vanadium oxide (CuV₂O₅), and mixtures thereof. CFx can be used as the second cathode material. The disclosed cathodes are constructed by sandwiching the first and second cathode materials with a current collector material. By controlling the ratio of the first cathode material to the second cathode material, it is said to be possible to control the capacity contribution of a primary cell at various voltage plateau regions, such that elective replacement and end-of-life indications may be provided.

The foregoing approaches for predicting the onset of depletion of Li/CFₓ cells have shortcomings that may limit their utility and widespread application. Relative to the blended cathode approach, the dilution or partial replacement of CFx with an additive will result in a cell with overall reduced energy density if the additive itself exhibits a lower specific energy. The theoretical capacity and energy density values for many common cathode materials have been published in D. Linden et al. “Handbook of Batteries,” 3^{rd} Ed. (2001), page 14.7. The data for a few of the more common materials are provided in Table 1.

TABLE 1

| | | Theoretical | |
|---|---|---|---|
| | Voltage | Faradic capacity | Specific Energy |
| Cathode Material | (VDC) | (Ah/g) | (Wh/kg) |
| SO₂ | 3.1 | 0.419 | 1170 |
| (CF)ₙ | 3.1 | 0.86 | 2180 |
| CuS | 2.15 | 0.56 | 1050 |
| MnO₂ | 3.5 | 0.31 | 1005 |
| AgV₂O_{5.5} | 3.24 | 0.282 | 655 |

The above-described Ebel et al. patent discloses a preferred cathode admixture using CFx at 67% by weight, a second cathode material such as copper sulfide (CuS) at 26% by weight, with binding and conductivity enhancing materials making up the balance (7%). According to Table 1, the theoretical specific energy of CFx (written as (CF)n in Table 1), is 2180 Wh-kg⁻¹, whereas the theoretical specific energy of copper sulfide (CuS) is much lower at 1050 Wh-kg⁻¹. Mixing the two materials in the ratio disclosed in the Ebel et al. reference would result in a cell with a theoretical specific energy of 2180×(67%)+1050×(26%)=1733 Wh-kg⁻¹. In contrast, a cathode fabricated with CFx as the only electrochemically active material (and comprising 7% binder and conductivity enhancer) will provide a cell with a theoretical specific energy of 2180 (Wh-kg⁻¹)×(93% active material)=2027 Wh-kg⁻¹. This is approximately 17% higher than the disclosed cathode formulation of Ebel et al. comprising CFx and CuS.

The reduction in specific energy becomes even more pronounced with the dilution of the fluorinated carbon with silver vanadate (AgₓV₂O₅), as disclosed in both the Ebel et al. and Weiss et al. patents. According to Table 1, the theoretical specific energy of AgV₂O_{5.5} is only 655 Wh-kg⁻¹. Using the disclosed Ebel et al. cathode admixture of 67% CFx and 26% AgV₂O_{5.5} additive (with 7% binder and conductivity enhancer), the resultant cell would have a theoretical specific energy of 2180×(67%)+655 ×(26%)=1631 Wh-kg⁻¹. A cell made with the CFx as the only electrochemically active cathode material (and 7% binder and conductivity enhancer) will have a theoretical specific energy of 2027 Wh-kg⁻¹ (as described above), and would thus have a 24% higher specific energy. Weiss et al. discloses a cathode admixture comprising CFx and an additive such as AgₓV₂O₅ formulated at exemplary weight ratios of 1:1, 2:1, 3:1 and 4:1, with 8% of the cathode comprising binder and conductivity enhancer. Taking the most favorable ratio of 4:1 CFx/AgₓV₂O₅ would result in a cell with a theoretical specific energy of 2180×(74%)+655×(18%)=1731 Wh-kg⁻¹. In contrast, a cathode fabricated with CFx as the only electrochemically active material (and comprising 8% binder and conductivity enhancer) will provide a cell with a theoretical specific energy of 2180 (Wh-kg⁻¹)×(92% active material)=2006 Wh-kg⁻¹. This is approximately 16% higher than the disclosed cathode formulation of Weiss et al. comprising CFx and AgₓV₂O₅ combined at the 4:1 ratio.

A second shortcoming to the use of additives with CFx materials is the compromised performance of a cell having different cathode materials because no single electrolyte system will provide optimum performance with both CFx and the additives proposed in the prior art. By way of example, it is known to those skilled in the art that the preferred electrolyte system for CFx is lithium tetrafluoroborate (LiBF₄) in a solvent of γ-butyrolactone (GBL), whereas a lithium/copper sulfide system (CuS additive disclosed by Ebel et al.) performs best with lithium perchlorate (LiClO₄) dissolved in a mixture of dimethoxyethane (DME) and tetrahydrofuran (THF). Similarly, a lithium/silver vanadate system (AgₓV₂O₅ additive disclosed by Weiss et al. and Ebel et al.) typically utilizes a lithium hexafluorarsenate (LiAsF₆) or lithium perdorate salt as the electrolyte, but the preferred solvent disclosed in Weiss et al. is a mixture of propylene carbonate and diglyme or glyme.

A further shortcoming common to the use of cathode additives is the increased complexity of the manufacturing process required to fabricate the cathode assembly. This additional complexity arises primarily from the solubility of the various prior art additives in liquids that are used to process and manipulate the cathode materials. Whereas aqueous liquids are suitable for processing CFx because it is insoluble in these liquids, both copper sulfide and silver vanadate are soluble in water, rendering them unacceptable as solvents for processing the cathode material.

Relative to the two-part cathode approach, each of the disadvantages associated with the blended cathode approach will also be present when using the techniques of the Tamura et al. and Gan et al. patents. For example, the introduction of a lower specific energy precursor material layer into a cathode according to Tamura et al. will reduce the energy density of the resultant cell. The use of Gan et al.'s recommended SVO cathode material will have the same energy density-lowering effect. As also described above relative to the blended cathode approach, a cell having a two-part cathode will still comprise only one electrolyte. This electrolyte will presumably be optimized for the primary cathode material, e.g., CFx, but will likely not be optimized for the secondary cathode material. Manufacturing will also be more complex than for a single-material cathode. The various cathode structures must be separately fabricated using different processes and then either pre-assembled in a separate cathode finishing operation or assembled with the other cell components during final assembly.

It is to improvements in the performance and application of Li/CFx batteries that the present invention is directed. In particular, what is needed is an improved CFx cathode material that provides a suitable indication of remaining cell capacity without the attendant disadvantages of the prior art approaches described above.

### SUMMARY OF THE INVENTION

The foregoing problems are solved and an advance in the art is provided by an electrochemical cell having an anode, a cathode, an electrolyte operatively associated with the anode and the cathode, and wherein the cathode comprises a blend of a first electrochemically active fluorinated carbon material and one or more additional electrochemically active fluorinated carbon materials. The fluorinated carbon materials provide an electrochemical cell voltage characteristic that may be used to predict remaining energy capacity as the electrochemical cell discharges during service. Advantageously, the cathode does not require other electrochemically active materials to achieve the desired voltage characteristic, thereby preserving the favorable energy density properties of fluorinated carbon.

In an exemplary embodiment disclosed herein, the cathode comprises a blend of fluorinated carbons based on two different carbonaceous starting materials, namely, fluorinated petroleum coke and fluorinated carbon black. The fluorinated petroleum coke has a fluorination level of approximately 60-62% and the fluorinated carbon black has a fluorination level of approximately 60-65%. The weight ratio of the fluorinated petroleum coke to the fluorinated carbon black is approximately 2:1. The cathode in the exemplary embodiment further comprises an acetylene black conductivity enhancer and a polytetrafluoroethylene (PTFE) inert binder. The cathode comprises (by weight) approximately 86% of the fluorinated carbon material, 8.6% acetylene black and 5.2% PTFE.

The invention further includes an implantable medical device comprising a housing, an electrical circuit in the housing, means controlled by the electrical circuit for interacting with biological tissue, and an electrochemical cell providing electrical energy to the electrical circuit. The electrochemical cell has an anode, a cathode and an electrolyte operatively associated with the anode and the cathode. The cathode comprises a blend of a first electrochemically active fluorinated carbon material and one or more additional electrochemically active fluorinated carbon materials. The fluorinated carbon materials provide an electrochemical cell voltage characteristic that may be used to predict remaining energy capacity as the electrochemical cell discharges during service, thereby allowing the implantable medical device to be explanted prior to electrochemical cell depletion.

### BRIEF DESCRIPTION OF THE DRAWINGS

The foregoing and other features and advantages of the invention will be apparent from the following more particular description of preferred embodiments of the invention, as illustrated in the accompanying Drawings in which:

FIG. 1 is a graph depicting the characteristic output voltage of a conventional Li/CFx cell;

FIG. 2 is a cross-sectional view of an electrochemical cell test fixture used to test cathode constructions in accordance with the present invention;

FIG. 3 is a graph that depicts the output voltage as a function of normalized cell capacity for two different electrochemical cells constructed using the test fixture of FIG. 2, one of which has a blended cathode in accordance with the invention;

FIG. 4 is a partial cross-sectional side view of an electrochemical “coin” cell that comprises a cathode constructed in accordance with the present invention; and

FIG. 5 is a plan view of an implantable medical device that is powered by the battery of FIG. 4.

### DETAILED DESCRIPTION OF EXEMPLARY EMBODIMENTS

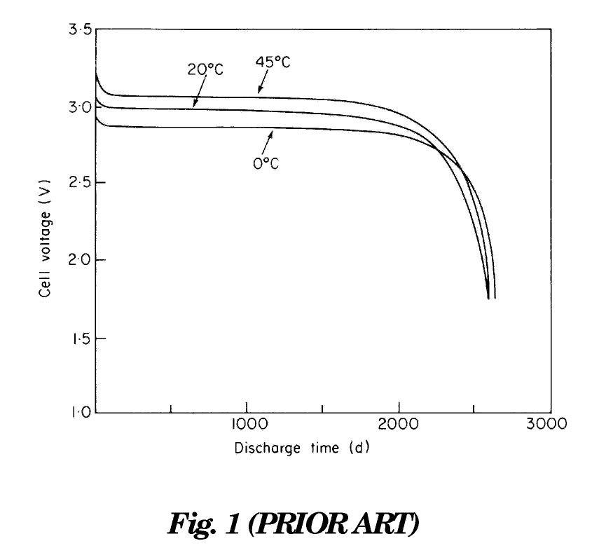

Applicant has discovered a novel cathode design for a Li/CFx cell whose electrochemically active materials comprise only CFx, yet which produces a characteristic voltage that may be used to predict remaining energy capacity as the cell discharges during service. In particular, by constructing the cathode with a non-homogenous blend of CFx materials, the voltage discharge curve of the resultant cell will be altered from the characteristic shape associated with Li/CFx cells shown in FIG. 1. Advantageously, the cathode does not require other electrochemically active materials to achieve the desired voltage characteristic, thereby preserving the favorable energy density properties of fluorinated carbon.

The inventive cathode comprises a blend of a first electrochemically active fluorinated carbon material and one or more additional electrochemically active fluorinated carbon materials. The preferred cathode blend comprises two fluorinated carbon materials. However, additional fluorinated carbon materials may be combined to create blends having three or more fluorinated carbon materials. The blended cathode materials comprise fluorinated carbons represented by the formula (CFₓ)ₙ, where x is a number between 0 and 2 and n is an indefinite number referring to the number of monomer units, and is typically greater than 2. The abbreviation CFx as used throughout the present application refers to the formula (CFₓ)ₙ as thus defined. The atomic weight of fluorine is 18.998 and the atomic weight of carbon is 12.011. The fluorination level of a given CFx material may be expressed as a percentage that represents the atomic weight contribution of the fluorine (18.998x) divided by the sum of the atomic weight contribution of the fluorine (18.998x) and the atomic weight contribution of the carbon (12.011). Thus, for a C₁F₁ stochiometry, the fluorination level would be 18.998/(18.998+12.011)=61.3%.

CFx is conventionally prepared from the reaction of fluorine gas with a crystalline or amorphous carbon. Graphite is an example of a crystalline form of carbon, while petroleum coke, coal coke, carbon black and activated carbon are examples of amorphous carbon. The reaction between fluorine and carbon is usually carried out at temperatures ranging from 250° C. to 600° C. in a controlled pressure environment. The reaction time is usually in the range of 1 to 24 hours. A variety of CFx materials are available from commercial sources, including materials derived from the fluorination of petroleum coke, carbon black and graphite.

Fluorinated carbons that may be used in forming a blended cathode as disclosed herein include fluorinated carbons that are based on different carbonaceous starting materials. For example, a blended cathode in accordance with the invention can be formed by blending fluorinated petroleum coke and fluorinated carbon black. Fluorinated petroleum coke is the most commonly used form of fluorinated carbon for Li/CFx cells and this material is described in numerous patents relating to battery construction and operation in the field of implantable medical use. The fluorinated petroleum coke for use in the present invention is preferably fully fluorinated to a fluorination level of approximately 60-62%. However, other fluorination levels could potentially also be used.

Fluorinated carbon black has been used as a cathode constituent in Li/CFx cells, as disclosed, for example, in U.S. Pat. No. 3,700,502 of Watanabe et al. and U.S. Pat. No. 4,271,242 of Toyoguchi et al. However, the Toyoguchi et al patent advises that an active carbon such as carbon black may be so amorphous as to have a discharge utility factor (60%) that is substantially less than that of fluorinated petroleum coke (90%), which is more crystallized. Fluorinated carbon black is also mentioned in the prior art as being combinable with fluorinated petroleum coke in order to improve the characteristic initial voltage discharge suppression typically associated with Li/CFx cells. See U.S. Pat. No. 4,765,968 of Shia et al., discussing Japanese Kokei No. 83 05,967 at column 3, lines 3-15. Shia et al. assert, however, that “ . . . fluorinated carbon blacks perform more poorly, particularly at high discharge rates, than do coke based fluorinated materials”, citing N. Watanabe et al., SOLID STATE IONICS, page 503 (1980). Shia et al. go on to caution that “[I]n light of this disclosure, it cannot be expected that fluorinated carbon black would be as effective in curing the voltage suppression phenomenon as is a coke-based fluorinated material.”Notwithstanding these teachings against the use of fluorinated carbon black in Li/CFx cells, applicant has determined that this material is effective in the context of the present invention, where the problem is one of providing a reliable elective replacement or end-of-service indication while maximizing energy density. The fluorinated carbon black for use in the present invention is preferably fully fluorinated to a fluorination level of approximately 60-65%. This range extends beyond the preferred fluorination range of the fluorinated petroleum coke material used in the inventive cathode disclosed herein. However, other fluorination levels could potentially also be used.

Any suitable mixing ratio may be used to blend the fluorinated CFx materials for use in the inventive cathode. For example, in a two-material blend comprising fluorinated petroleum coke and fluorinated carbon black, the weight ratio of the fluorinated petroleum coke to the fluorinated carbon black may be approximately 2:1. As described by way of example below, a cathode blended in this matter produced an Li/CFx cell whose voltage discharge curve exhibited a gradual negative slope. The use of other weight ratios for the cathode materials will no doubt produce different voltage discharge curves, as will the use of cathode material blends other than a mixture of fluorinated petroleum coke and fluorinated carbon black, or which include more than two fluorinated carbon materials.

Cathodes in accordance with the present invention will preferably include the usual non-electrochemically active materials, such as a conductivity enhancer and a binder. A preferred conductivity enhancer is acetylene black, although other materials such as carbon black, graphite or mixtures thereof may also be used. Metals such as nickel, aluminum, titanium and stainless steel in powder form may likewise be used. The binder is preferably an aqueous dispersion of a fluorinated resin material, such as a polytetrafluoroethylene (PTFE) or polyvinylidene fluoride (PVDF) emulsion. For the present invention, an inert PTFE emulsion is the preferred binder material. Any suitable mixing ratio of the fluorinated carbon blend, the conductivity enhancer and the binder may be used. For example, as described by way of example below, a cathode in accordance with the present invention may comprise 86% of the fluorinated carbon material, 8.6% conductivity enhancer and 5.2% binder.

During fabrication of the CFx cathode, the fluorinated carbon materials, which come in powder form, are mixed with the conductive additive. The CFx and conductive filler are then combined with the binder and blended together by hand (e.g., mortar and pestle) or by using a mixer or ball mill. During this processing, the blend may be wetted with a suitable liquid phase pore-former that is readily removable from the blend following processing. An exemplary pore-former comprises a 1:1 ratio of isopropyl alcohol and water that can be volatilized by conventional means at temperatures between 50° C. and 250° C. to convert the mixture into a desired cathode structure. The pore-former can be added to the mixture in a quantity representing 10% by weight of the total admixture. The wetted cathode mixture is intimately blended and then pressed into a homogeneous cathode sheet or otherwise shaped. If pressed into sheet form, the dried material can be processed into pellets that may then be converted by conventional polymer processing techniques into desired cathode shapes. The pore-forming liquid can be volatilized following pressing or during subsequent processing. After fabrication of the shaped cathode, the cathode may then be pressed or otherwise affixed onto a suitable positive current collector selected from the group consisting of stainless steel, titanium, tantalum, platinum and gold.

An Li/CFx cell can be fabricated using the inventive cathode in accordance with conventionally known battery construction techniques. As is well known in the art, such cells make use of an electrochemically active anode coupled to the electrochemically active cathode by way of a non-aqueous electrolyte. The electrolyte serves as a medium for the migration of ions in atomic or molecular form between the anode and the cathode during the cell electrochemical reactions, resulting in a negative charge at the anode and a positive charge at the cathode.

The active anode material of an Li/CFx cell may comprise lithium, potassium, sodium, calcium, magnesium, aluminum, or other light metals found in Groups IA, IIA and IIB of the Periodic Table of Elements, together with alloys and intermetallic compounds thereof. Lithium is preferred for use in the present invention because of its ductility and ease of assembly, and because it possesses a high energy-to-weight ratio. The anode, which is typically formed as a thin sheet or foil comprising the anode material, is generally mounted to a metallic backing element that acts as a negative anode current collector. Materials that are commonly used for the anode current collector in Li/CFx cells include titanium, titanium alloy or nickel.

Li/CFx cells utilize non-aqueous electrolytes. As used herein, the term “non-aqueous” allows for the presence of minor amounts of water as an impurity. Such minor amounts of water can be present in the electrolyte because of the insolubility of fluorinated carbons, even with respect to water. The non-aqueous electrolyte used in Li/CFx cells typically comprises an inorganic, ionically conductive salt dissolved in a non-aqueous solvent to produce an ionically conductive solution. Lithium tetrafluoroborate (LiBF₄) is one exemplary salt that may be used as the electrolyte solute. Other lithium salts may also be used, including LiPF₆, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures of the foregoing. The electrolyte non-aqueous solvent may comprise compounds such as lactones, alykylene carbonates, lactams, polyethers, cyclic ethers, cyclic sulfones, dialkylsulfites, monocarboxylic acid esters, and alkylnitriles. Typical preferred solvents include γ-butyrolactone (GBL), tetrahydrofuran (THF), methyl tetrahydrofuran, sulfolane, ethyl acetate, methyl acetate (MA), diglyme, triglyme, tetraglyme, dimethyl carbonate (DMC), 1,2-dimethyloxyethane (DME), 1,1- and 1,2-diethoxyethane (DEE), 1-ethoxy, 2-methoxyethane (EME), ethyl methyl carbonate (EMC), methyl propyl carbonate, ethyl propyl carbonate, diethyl carbonate (DEC), dipropyl carbonate, propylene carbonate (PC), ethylene carbonate (EC), butylene carbonate, acetonitrile, dimethyl sulfoxide, dimethyl formamide, dimethyl acetamide, γ-valerolactone, N-methyl-pyrrolidinone (NMP), and mixtures of the foregoing. For the present invention, the preferred inorganic, ionically conductive salt is 1.0-1.4 molar lithium tetrafluoroborate and the preferred non-aqueous solvent is GBL.

The electrolyte used in Li/CFx cells is carried in a porous separator disposed between the anode and the cathode. The separator is electrically insulative, chemically unreactive with the electrochemically active materials of the anode and cathode, and insoluble in the electrolyte. The porosity of the separator is sufficient to allow the electrolyte to flow therethrough during the cell's electrochemical reactions. Exemplary separator materials include fabrics woven from polypropylene and fluropolymeric fibers including polyvinylidene fluoride, polyethylenetetrafluorethylene, and polyethylenechlorotrifluoroethylene used either alone or laminated with a fluoropolymeric microporous film or membrane, non-woven glass, polypropylene, polyethylene, glass fiber materials, ceramics, and polytetrafluoroethylene (PTFE) or polypropylene films and membranes. A preferred separator for use in the present invention comprises polypropylene non-woven fabric or cloth and a superimposed microporous polypropylene film. Preferably, the non-woven fabric faces the cathode and the poypropylene microporous film faces the anode. In this orientation, the non-woven fabric will act as a wicking material to more effectively wet the cathode. It will also serve as a barrier to protect against puncture of the polypropylene film due to loose carbon particles.

### EXAMPLE

A CFx cathode was constructed using a non-homogenous blend of fluorinated petroleum coke and fluorinated carbon black as described above. The fluorinated petroleum coke was produced through the direct fluorination of petroleum coke to a yield a material with a fluorine content of 60% to 62%. This material is available from Lodestar Company of Howell, N.J. under the product designation “PC/10.” The fluorinated carbon black was produced through the direct fluorination of carbon black to yield a material with a fluorination level of 60% to 65%. This material is available from Lodestar Company under the product designation “CB65.” The two fluorinated carbon materials were blended at a weight ratio of two parts fluorinated petroleum coke to one part fluorinated carbon black to yield a homogeneous, electrochemically active cathode material. The blended material was uniformly mixed with acetylene black carbon to increase the electrical conductivity of the final cathode mixture. A PTFE emulsion (where the PTFE content is 60% in an aqueous suspension) was added to the cathode admixture to act as an inert binder. The composition (by weight) of the resulting cathode mixture was 86.2% cathode active material, 8.6% acetylene black and 5.2% solid PTFE. An additional liquid phase comprising a 1:1 ratio of isopropyl alcohol and water was added to the mixture in a quantity representing 10% by weight of the total admixture. This cathode mixture was intimately blended by means of a mortar and pestle and pressed into a homogeneous cathode sheet.

The resulting paste was pressed to a thickness of 0.010″ and then dried at 80° C. for a period of 16 hours. Individual cathode components were cut from the sheet. A lithium metal anode was cut to a similar size. The thickness of the anode was selected so that the mass of the anode had an equivalent electrochemical capacity in excess of that of the corresponding cathode, thus achieving a cathode limited design. Disposed between the anode and cathode was a micro-porous polypropylene separator that maintained a physical separation between the electrodes.

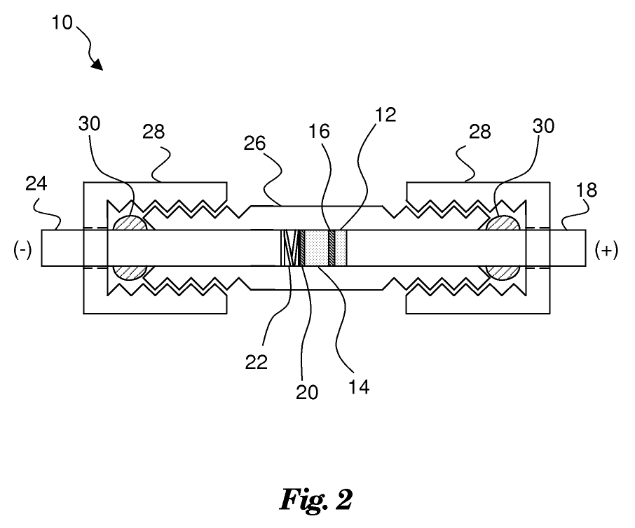

FIG. 2 shows a cell stack test fixture assembly 10 that includes the aforementioned blended CFx cathode, a lithium anode and a microporous polypropylene separator, respectively designated by reference numerals 12, 14 and 16. A cathode current collector was provided by a stainless steel rod 18 appropriately sized to the diameter of the cathode 12. An anode current collector was provided by a metal disk 20 made from 304 stainless steel placed between the lithium anode and a conductive metallic spring 22 made from 302 stainless steel. The spring 22 was disposed between the disk 20 and another stainless steel rod 24. The foregoing components of the assembly 10 were inserted into a tubing union 26 fabricated from a material such as PTFE or PVFD that is electrically non-conductive and also non-reactive with the cell materials. Each threaded end of the union 26 was fitted with a nut 28 (made of the same material as the union) for compressing a ferrule 30 at each end of the union to seal the rods 18 and 20 when tightened.

An electrolyte comprising a 1 molar solution of lithium tetrafluoroborate in a γ-butyrolactone solvent was added to the separator 16 in a quantity not less than ten times the weight of the cathode component. The rods 18 and 24 were pressed together until the spring 22 was at 50% of its free length to ensure intimate contact between the active cell materials during the cell discharge. Both of the rods 18 and 24 were sealed to the union 26 by means of a compression seal (not shown).

The assembled cell was allowed to stabilize at 37° C. for 16 hours following assembly. Constant resistance discharge was then achieved through the connection of the positive polarity rod 18, which is in electrical contact with the CFx cathode 12, to the negative polarity rod 24, with is in electrical contact with the lithium anode 14, through a 100,000 Ω resistor to achieve a discharge rate of 0.027 milliamperes.

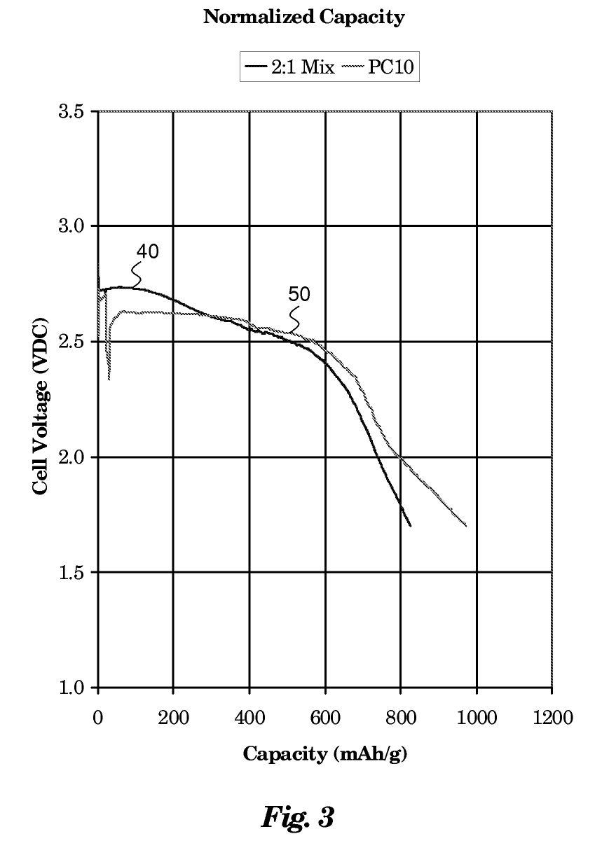

The resulting discharge curve is displayed as curve 40 in FIG. 3, which is a graph of cell voltage as a function of cell capacity normalized to the weight of cathode 12 to illustrate gravimetric energy density. The voltage discharge curve 40 for the composite cathode exhibits a definite slope over all but the first 10%-15% of the discharge capacity. It will be appreciated that a relationship can be easily established between the loaded cell voltage and the relative cell capacity so that the cell voltage at any stage of depletion may be used to predict the level of cell depletion and therefore the remaining discharge capacity during service.

The discharge curve 50 of FIG. 3 is the voltage discharge characteristic for an identically constructed cell stack assembly except with a cathode formulated from a single petroleum coke-based fluorinated carbon material, as is typical for many Li/CFx cells. The CFx material was fluorinated petroleum coke having a fluorine content of 60-62%. The composition of the resulting cathode (by weight) was 86.2% fluorinated petroleum coke, 8.6% acetyline black and 5.2% solid PTFE. All other processing conditions were the same as for the blended cathode 12 described above. The discharge rate for testing the non-blended cathode was also 0.027 milliamperes. Unlike the discharge curve 40, the voltage characteristic for discharge curve 50 is nearly flat until the cell is approximately 75% depleted, at which time the slope increases significantly. Because of the flat discharge characteristic, the cell voltage cannot be used to predict the remaining capacity until the cell is almost entirely depleted.

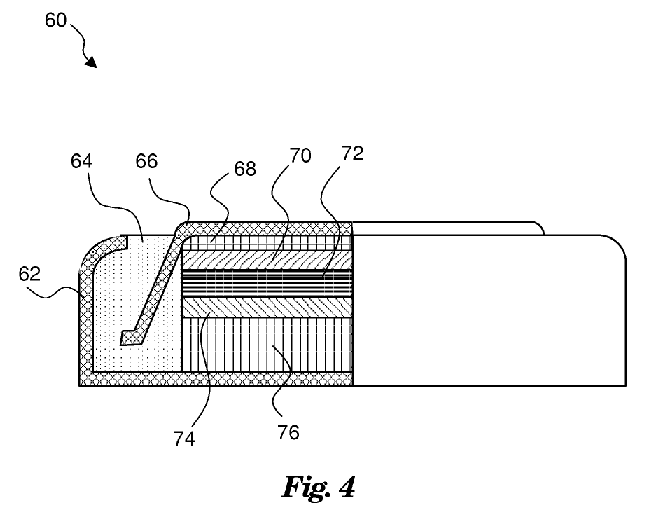

Turning now to FIG. 4, an exemplary Li/CFx battery 60 is shown that may be constructed in accordance with the present invention to provide an indication of remaining capacity. The battery 60 has a so-called “coin” style construction of the type that is commonly used in commercial devices. Other form factor configurations may also be used. The battery 60 includes a case 62, a gasket 64, a cap 66, a spring 68, a backing plate 70, a lithium anode 72, a separator 74 and a blended CFx cathode 76. The case 62 and the cap 66 are made from a conductive metal such as stainless steel insofar as these components respectively provide the positive and negative terminals of the battery 60. The gasket 64 is made from polypropylene. The spring 68 is made from a conductive metal such as stainless steel insofar as it lies in the electrical pathway between the cap 66 and the anode 72. The backing plate 70 is likewise made from a conductive metal such as stainless steel. The separator 74 and the anode 72 can be respectively constructed using any suitable material conventionally used in Li/CFx cells for such structures, as previously described. The blended CFx cathode 76 can be constructed using the same materials and techniques used to form the cathode 12 of FIG. 2. Thus, the cathode 76 will comprise a blend of a first electrochemically active fluorinated carbon material and one or more additional electrochemically active fluorinated carbon materials. The fluorinated carbon materials of the cathode 76 provide an electrochemical cell voltage characteristic that may be used to predict remaining energy capacity as the battery 60 discharges during service, thereby allowing the battery to be explanted prior to electrochemical cell depletion. During assembly of the battery 60, the battery components 66 through 76 may be stacked within the case 62. The cap 60 is mounted to the assembly and the case 62 periphery is rolled or crimped over the gasket and cap 60 in order to seal the battery.

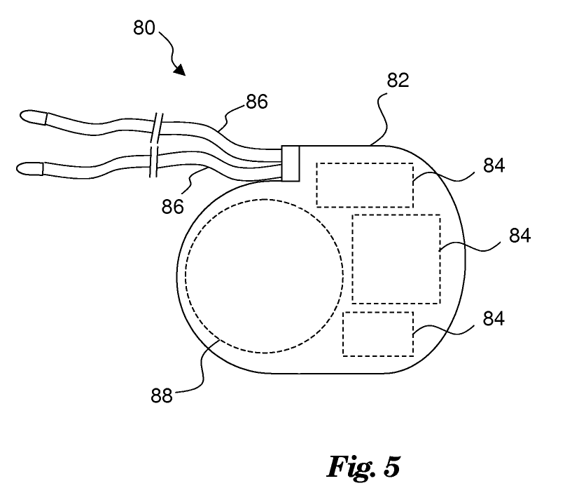

Turning now to FIG. 5 an exemplary implantable device 80 is shown that may be constructed in accordance with the invention to provide an indication of remaining capacity. The implantable medical device 80, which could be a pacemaker, an infusion device, or otherwise, includes a housing 82, one or more electrical circuit modules 84 in the housing (three are shown), a pair of physiologic electrodes 86 or other means (such as an infusion catheter) controlled by the electrical circuit 84 for interacting with biological tissue, and an electrochemical battery cell 88 providing electrical energy to the electrical circuit. The battery 88 is an Li/CFx cell that may be constructed with a blended CFx cathode in the same manner as the battery 60 of FIG. 4. As such, the battery 88 will have a lithium anode, a blended CFx cathode and a non-aqueous electrolyte operatively associated with the anode and the cathode. Like the battery 60, the cathode of the battery 88 will comprise a blend of a first electrochemically active fluorinated carbon material and one or more additional electrochemically active fluorinated carbon materials. The fluorinated carbon materials provide an electrochemical cell voltage characteristic that may be used to predict remaining energy capacity as the battery 88 discharges during service, thereby allowing the implantable medical device 80 to be explanted prior to electrochemical cell depletion.

Accordingly, the use of two or more fluorinated carbon materials to create a blended carbonaceous cathode for a lithium primary cell has been disclosed. The blended cathode results in a cell with a discharge voltage characteristic that allows the prediction of remaining cell capacity by way of a simple voltage measurement. It should, of course, be understood that the description and the drawings herein are merely illustrative, and it will be apparent that the various modifications, combinations and changes can be made of these materials disclosed in accordance with the invention. It should be understood, therefore, that the invention is not to be in any way limited except in accordance with the spirit of the appended claims and their equivalents.

What is claimed is:

1. An electrochemical cell, comprising:
an anode;
a cathode;
an electrolyte operatively associated with said anode and said cathode;
said cathode comprising a blend of a first electrochemically active fluorinated carbon material and one or more additional electrochemically active fluorinated carbon materials; and
said fluorinated carbon materials providing an electrochemical cell voltage characteristic that may be used to predict remaining energy capacity as said electrochemical cell discharges during service.

2. An electrochemical cell in accordance with claim 1 wherein said first fluorinated carbon material comprises fluorinated petroleum coke.

3. An electrochemical cell in accordance with claim 1 wherein said one or more additional fluorinated carbon materials comprise fluorinated carbon black.

4. An electrochemical cell in accordance with claim 2 wherein said fluorinated petroleum coke has a fluorination level of approximately 60-62%.

5. An electrochemical cell in accordance with claim 3 wherein said fluorinated carbon black has a fluorination level of approximately 60-65%.

6. An electrochemical cell in accordance with claim 1 wherein said cathode comprises a fluorinated petroleum coke-fluorinated carbon black blend in which said first fluorinated carbon material comprises fluorinated petroleum coke having a fluorination level of approximately 60-62% and said one or more additional fluorinated carbon materials comprise fluorinated carbon black having a fluorination level of approximately 60-65%.

7. An electrochemical cell in accordance with claim 6 wherein the weight ratio of said fluorinated petroleum coke to said fluorinated carbon black in said fluorinated petroleum coke-fluorinated carbon black blend is approximately 2:1.

8. An electrochemical cell in accordance with claim 7 wherein said cathode further comprises a conductivity enhancer and an inert binder.

9. An electrochemical cell in accordance with claim 8 wherein said conductivity enhancer comprises acetylene black and said inert binder comprises polytetrafluoroethylene (PTFE).

10. An electrochemical cell in accordance with claim 9 wherein said cathode comprises (by weight) approximately 86% of said fluorinated petroleum coke-fluorinated carbon black blend, 8.6% acetylene black and 5.2% PTFE.

11. An implantable medical device, comprising:
a housing:
an electrical circuit in said housing;
means controlled by said electrical circuit for interacting with biological tissue; and
an electrochemical cell providing electrical energy to said electrical circuit, said electrochemical cell comprising:
an anode;
a cathode;
an electrolyte operatively associated with said anode and said cathode;
said cathode comprising a blend of a first electrochemically active fluorinated carbon material and one or more additional electrochemically active fluorinated carbon materials; and
said fluorinated carbon materials providing an electrochemical cell voltage characteristic that may be used to predict remaining energy capacity as said electrochemical cell discharges during service.

12. An implantable medical device in accordance with claim 11 wherein said first fluorinated carbon material comprises fluorinated petroleum coke.

13. An implantable medical device in accordance with claim 11 wherein said one or more additional fluorinated carbon materials comprise fluorinated carbon black.

14. An implantable medical device in accordance with claim 12 wherein said fluorinated petroleum coke has a fluorination level of approximately 60-62%.

15. An electrochemical cell in accordance with claim 13 wherein said fluorinated carbon black has a fluorination level of approximately 60-65%.

16. An implantable medical device in accordance with claim 11 wherein said cathode comprises a fluorinated petroleum coke-fluorinated carbon black blend in which said first fluorinated carbon material comprises fluorinated petroleum coke having a fluorination level of approximately 60-62% and said one or more additional fluorinated carbon materials comprise fluorinated carbon black having a fluorination level of approximately 60-65%.

17. An implantable medical device in accordance with claim 16 wherein the weight ratio of said fluorinated petroleum coke to said fluorinated carbon black in said fluorinated petroleum coke-fluorinated carbon black blend is approximately 2:1.

18. An implantable medical device in accordance with claim 17 wherein said cathode further comprises a conductivity enhancer and an inert binder.

19. An implantable medical device in accordance with claim 18 wherein said conductivity enhancer comprises acetylene black and said inert binder comprises polytetrafluoroethylene (PTFE).

20. An implantable medical device in accordance with claim 19 wherein said cathode comprises (by weight) approximately 86% of said fluorinated petroleum coke-fluorinated carbon black blend, 8.6% acetylene black and 5.2% PTFE.

21. An electrochemical cell, comprising:
an anode;
a cathode;
an electrolyte operatively associated with said anode and said cathode;
said cathode comprising a blend of a first electrochemically active fluorinated carbon material and a second electrochemically active fluorinated carbon material;
said fluorinated carbon materials providing an electrochemical cell voltage characteristic that may be used to predict remaining energy capacity as said electrochemical cell discharges during service;
said first fluorinated carbon material comprising fluorinated petroleum coke having a fluorination level of approximately 60-62% and said second fluorinated carbon materials comprising fluorinated carbon black having a fluorination level of approximately 60-65%;
said fluorinated petroleum coke and said fluorinated carbon black being present at a ratio of approximately 2:1;
said cathode comprises an acetylene black conductivity enhancer and a polytetrafluoroethylene (PTFE) inert binder; and
said cathode comprising (by weight) approximately 86% of said first and second fluorinated carbon materials, 8.6% acetylene black and 5.2% PTFE.
